(19) United States
(12) Patent Application Publication
(10) Pub. No.: US 2014/0146231 A1
(43) Pub. Date: May 29, 2014

(54) DISPLAY APPARATUS AND IMAGE CAPTURING METHOD THEREOF

(71) Applicants: Liang-Ting Lin, Kaohsiung City (TW); Hung-Chun Yang, Hsinchu City (TW); Shan-Tai Chen, Hsinchu City (TW)

(72) Inventors: Liang-Ting Lin, Kaohsiung City (TW); Hung-Chun Yang, Hsinchu City (TW); Shan-Tai Chen, Hsinchu City (TW)

(73) Assignee: Faraday Technology Corp., Hsinchu (TW)

(21) Appl. No.: 13/754,913

(22) Filed: Jan. 31, 2013

(30) Foreign Application Priority Data
Nov. 29, 2012 (TW) 101144825

(51) Int. Cl. H04N 5/66

(52) U.S. Cl. CPC H04N 5/66
USPC 348/554

(57) ABSTRACT

A display apparatus and an image capturing method are provided. The display apparatus includes a receiving unit, a processing unit, a display panel, a display output interface, and a capturing unit. The receiving unit is coupled to a data bus and receives video stream data provided by an external video source. The processing unit is coupled to the data bus and processes the video stream data to generate display data. The display output interface is coupled to the processing unit and the display panel, receives the display data, and drives the display panel to display an image frame. The capturing unit is coupled to the data bus and captures all or part of the image frame according to a capturing command issued by an external device, so as to obtain captured target data. The capturing unit also transmits the captured target data back to the external device.

### CROSS-REFERENCE TO RELATED APPLICATION

This application claims the priority benefit of Taiwan application serial no. 101144825, filed on Nov. 29, 2012. The entirety of the above-mentioned patent application is hereby incorporated by reference herein and made a part of this specification.

### BACKGROUND OF THE INVENTION

1. Field of the Invention

The invention relates to a display apparatus, and more particularly to a display apparatus capable of capturing image data and an image capturing method of the display apparatus.

2. Description of Related Art

With the progress toward science and technology as well as the rapid development of electronic industry, digital products including mobile phones, digital cameras, desktop computers, notebook computers, and tablet PCs have been developed towards easy operation, multiple functions, and attractive appearance. When these products are used, display apparatuses act as indispensable operational interfaces because the display apparatuses may facilitate the use of these products.

In the event that various images are displayed by the display apparatuses, users may occasionally intend to capture the images that are being displayed by the display apparatuses rather than write down the information contained in the displayed images with pens and paper. According to the conventional image capturing technology, an image capturing function is often installed in a display card (graphics card) or an operating system (OS) of a computer; after a user issues a capturing command, a displayed image is captured from the memory of the computer or the memory of the display card (graphics card), e.g., the print screen function in an operating system of Microsoft.

However, the displayed images may not be captured nor completely captured by performing the aforesaid image capturing method because the limited specifications of various operating systems or display cards (graphics cards), or changes/mismatch of software programs on the operating systems. Alternatively, a user may attempt to execute a specific software program to capture the images, and a screen of executing the software program may appear on the display apparatus, such that the user is not able to capture the desired target images. From another perspective, in an image broadcast system, a broadcaster may intend to learn whether the broadcast images are displayed by each display apparatus. At this time, the broadcaster may hope to timely observe the video/image displayed by each display apparatus for fear that errors of image data may occur during data transmission or data processing. These errors may cause the display apparatuses not to display the correct or desired broadcast images.

### SUMMARY OF THE INVENTION

The invention is directed to a display apparatus and an image capturing method thereof, so as to capture from the display apparatus an image that is being displayed on a screen of the display apparatus.

In an embodiment of the invention, a display apparatus that includes a receiving unit, a processing unit, a display panel, a display output interface, and a capturing unit is provided. The receiving unit is coupled to a data bus and receives video stream data provided by an external video source. The processing unit is coupled to the data bus and processes the video stream data to generate display data. The display output interface is coupled to the processing unit and the display panel, receives the display data, and thereby drives the display panel to display an image frame. The capturing unit is coupled to the data bus and captures all or part of the image frame according to a capturing command issued by an external device, so as to obtain captured target data. The capturing unit also transmits the captured target data back to the external device.

According to an embodiment of the invention, the receiving unit receives the video stream data provided by the external video source through a universal serial bus (USB) interface, a thunderbolt interface, a high definition multimedia interface (HDMI), a DisplayPort interface, or a video graphics array (VGA) interface.

According to an embodiment of the invention, the capturing unit transmits the captured target data back to the external device through a USB interface, a thunderbolt interface, an HDMI, or a DisplayPort interface.

According to an embodiment of the invention, the capturing unit receives the capturing command issued by the external device through a USB interface, a thunderbolt interface, an HDMI, or a DisplayPort interface.

According to an embodiment of the invention, the display apparatus further includes a memory that is coupled to the data bus and stores the video stream data or the display data.

According to an embodiment of the invention, the capturing unit captures from the memory the video stream data or the display data as the captured target data.

According to an embodiment of the invention, the capturing unit captures content of a frame buffer of the display output interface as the captured target data.

According to an embodiment of the invention, the capturing unit further adjusts resolution of the captured target data according to the capturing command.

According to an embodiment of the invention, the display apparatus further includes a trigger unit. The trigger unit is coupled to the data bus, detects a trigger signal, and outputs a capture activation signal to the capturing unit through the data bus.

According to an embodiment of the invention, the capturing unit outputs the capture activation signal to the external device, so as to trigger the external device to issue the capturing command.

According to an embodiment of the invention, the external device provides the external video source.

According to an embodiment of the invention, the external video source is provided by a second external device.

In an embodiment of the invention, an image capturing method of a display apparatus is provided, and the image capturing method includes following steps. Video stream data are received from a receiving unit. The video stream data are processed by a processing unit to generate display data. A display panel is driven by a display output interface according to the display data, so as to display an image frame. All or part of the image frame is captured by a capturing unit according to a capturing command issued by an external device, so as to obtain captured target data. The captured target data are transmitted back to the external device by the capturing unit.

In the display apparatus and the image capturing method thereof described herein, the capturing unit of the display apparatus may, according to the capturing command issued by the external device, be applied to capture the image frame that is being displayed on the display apparatus, obtain the captured target data, and transmit the captured target data back to the external device. Since the image data may be captured from the display apparatus, a user of the display apparatus may easily obtain the desired image.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic functional block view illustrating a display apparatus according to an embodiment of the invention.

FIG. 2 is a flow chart of an image capturing method according to an embodiment of the invention.

FIG. 3 is a schematic view illustrating an image frame according to an embodiment of the invention.

FIG. 4 is a schematic functional block view illustrating a display apparatus and an external device according to another embodiment of the invention.

FIG. 5 is a flow chart of an image capturing method according to another embodiment of the invention.

FIG. 6 is a schematic functional block view illustrating a display apparatus and an external device according to another embodiment of the invention.

FIG. 7 is a schematic functional block view illustrating a display apparatus and an external device according to another embodiment of the invention.

FIG. 8 is a flow chart of an image capturing method according to another embodiment of the invention.

FIG. 9 is a schematic view briefly illustrating an scenario of applying the display apparatus according to another embodiment of the invention.

### DETAILED DESCRIPTION OF DISCLOSED EMBODIMENTS

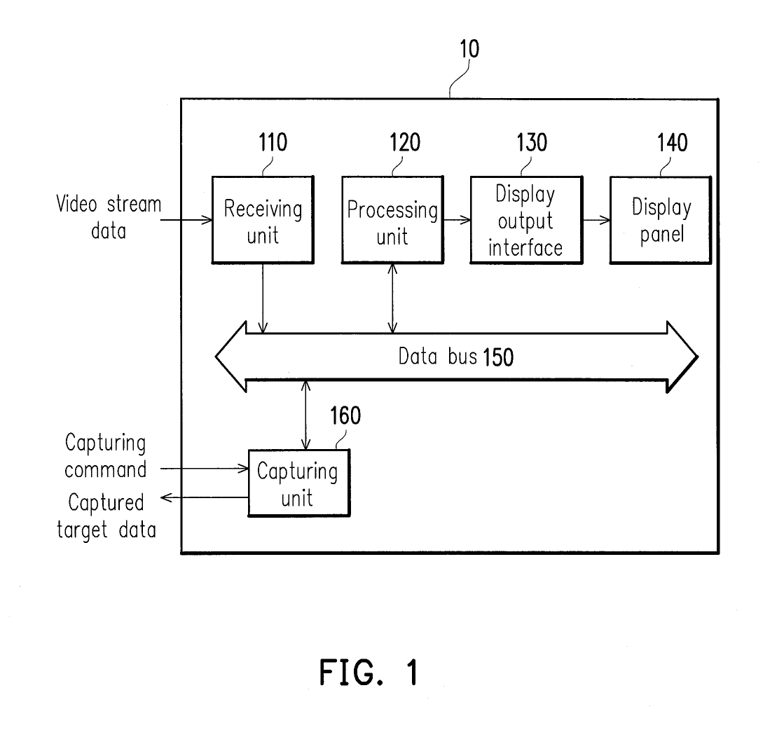

FIG. 1 is a schematic functional block view illustrating a display apparatus according to an embodiment of the invention. With reference to FIG. 1, the display apparatus 10 is, for instance, a liquid crystal display (LCD), a light-emitting diode (LED) display, a field emission display (FED), a plasma display, an organic light-emitting diode (OLED) display, or any other display apparatus that may display an image frame after receiving a signal or data provided by a video source. The display apparatus 10 includes a receiving unit 110, a processing unit 120, a display output interface 130, a display panel 140, and a capturing unit 160. These components in the display apparatus 10 transmit data or signals among one another through a data bus 150.

The receiving unit 110 is coupled to the data bus 150 and receives video stream data provided by an external video source. The processing unit 120 is coupled to the data bus 150. Here, the processing unit 120 is, for instance, a central processing unit (CPU), a microprocessor, a digital signal processor (DSP), and so forth. The processing unit 120 serves to process the video stream data to generate display data, and the image processing herein may include adjustment of image contrast, brightness of images, color of images, or resolution of images.

The display output interface 130 is coupled to the processing unit 120 through a low-voltage differential signaling (LVDS) interface, a mini-LVDS interface, or a digital-RGB interface, for instance. In some embodiments of the invention, the display output interface 130 may include a scalar, a timing controller, a source driver, and/or a gate driver. The display output interface 130 is coupled to the display panel 140. Here, the display output interface 130 receives the display data provided by the processing unit 120 and thereby drives the display panel 140 to display an image frame. The display panel 140 is, for instance, an LCD panel, a plasma display panel, an OLED panel, or any other suitable display panel.

The capturing unit 160 is coupled to the data bus 150 and captures the image frame displayed on the display panel 140 according to a capturing command issued by an external device (not shown in FIG. 1). Here, the capturing unit 160 may capture all or part of the image frame to obtain captured target data. The capturing unit 160 also transmits the captured target data back to the external device. The external device is, for instance, a PC host, an advertisement/broadcast host, an advertisement/broadcast content inspection instrument, or any other external electronic device that is equipped with a two-way communication circuit (e.g., a USB controller) and capable of issuing the capturing command. The invention is not limited thereto.

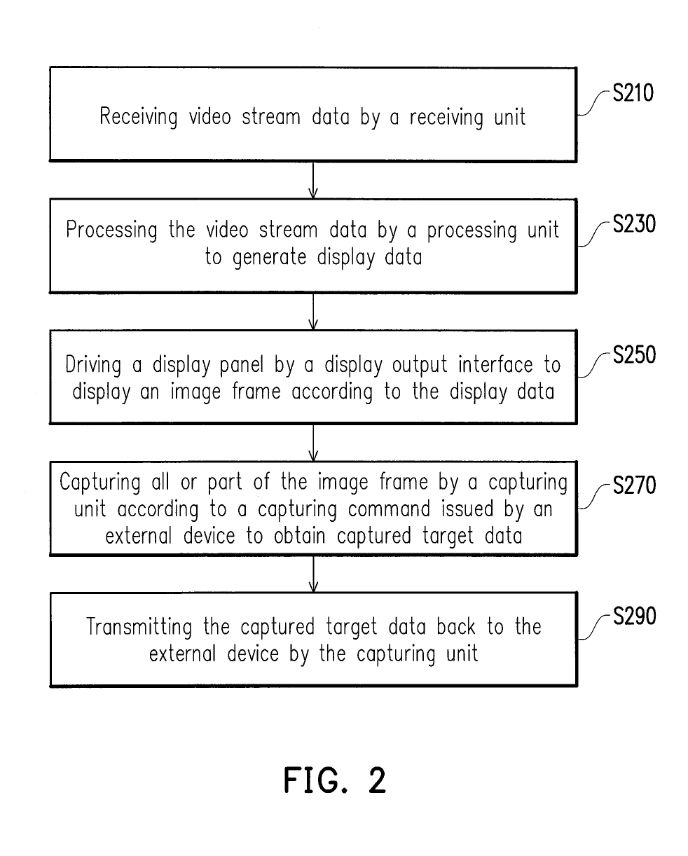

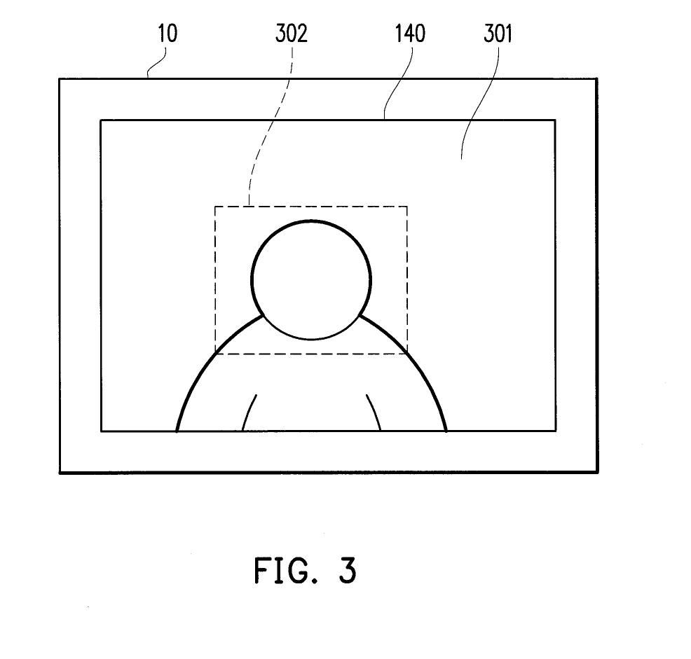

FIG. 2 is a flow chart of an image capturing method according to an embodiment of the invention. FIG. 3 is a schematic view illustrating an image frame of a display apparatus according to an embodiment of the invention. With reference to FIG. 1 to FIG. 3, the image capturing method is initiated by performing step S210. In step S210, the receiving unit 110 of the display apparatus 10 receives video stream data. For instance, the receiving unit 110 of the display apparatus 10 may receive a television video signal sent by a television signal source, an image signal output by a display card of a computer system, an advertisement/broadcast image signal output by an advertisement/broadcast host, or image data output by a multi-functional DVD player, which should not be construed as a limitation to the invention.

In step S230, the processing unit 120 processes the video stream data to generate display data. That is, after the display apparatus 10 receives the video stream data from an external video source, the processing unit 120 performs an image processing step (e.g., image scaling/resizing, brightness adjustment, and so forth) on the video stream data. In step S250, the display output interface 130 drives the display panel 140 to display an image frame 301 according to the display data output by the processing unit 120, such that the display apparatus 10 may eternally displays the image frame 301, and that people who watch the display apparatus 10 are able to receive the information released by the image frame 301 through the display apparatus 10.

In step S270, the capturing unit 160 captures part of the image frame 302 or all of the image frame 301 according to a capturing command issued by an external device to obtain captured target data. Particularly, when the capturing unit 160 receives the capturing command issued by the external device, it indicates that the external device or a user intends to capture the image frame that is being displayed on the display apparatus 10. For instance, a remote advertisement/broadcast content inspection instrument is able to issue a capturing command to the capturing unit 160, so as to inspect/monitor whether the display apparatus 10 correctly display the content of the advertisement/broadcast. As shown in FIG. 3, the capturing unit 160 may capture all the image frame 301 or part of the image frame 302 according to the content or the setting of the capturing command.

In step S290, the capturing unit 160 transmits the captured target data back to the external device. Through the capturing unit 160, the external device is able to capture the image frame displayed by the display apparatus 10. In addition, according to an embodiment of the invention, the captured target data may be processed by the capturing unit 160, such that an image file of the captured target data may be generated. The image file is then transmitted to the external device by the capturing unit 160. According to another embodiment, after the external device receives the captured target data provided by the capturing unit 160, the external device generates an image file of the captured target data. The image file of the captured target data may be in any image format (e.g., JPG, GIF, JPEG, or BMP) according to the actual design demands, and the invention is not limited thereto. Thereby, the external device or the user is capable of completely capturing the image frame 301 displayed by the display apparatus 10; the user is allowed to capture the observed image frame as well as save or watch the image frame in the image file format.

It should be mentioned that the display apparatus 10 requires a communication interface to communicate with the external video source and receive the video stream data provided by the external video source. In addition, the capturing unit 160 of the display apparatus 10 requires a communication interface for receiving the capturing command from the external device and outputting the captured target data through the communication interface. For instance, the receiving unit 110 may receive the video stream data provided by the external video source through a USB interface, a thunderbolt interface, an HDMI, a DisplayPort interface, or a VGA interface. The capturing unit 160 may also transmit the captured target data back to the external device through the USB interface, the thunderbolt interface, the HDMI, or the DisplayPort interface. Besides, the capturing unit 160 may receive the capturing command issued by the external device through the USB interface, the thunderbolt interface, the HDMI, or the DisplayPort interface. Through different interfaces or the same interface, the receiving unit 110 and the capturing unit 160 may communicate with the external device, which will be elaborated in the following embodiments.

Note that the invention is not limited to the previous embodiments; based on actual requirements, changes may be made to the previous embodiments. For instance, the resolution of the captured target data may be identical to the resolution of the displayed image in an embodiment of the invention. In another embodiment, the resolution of the captured target data may be adjusted according to the capturing command. Further, according to another embodiment, the display apparatus may further include a memory, which will be explained in the following embodiment.

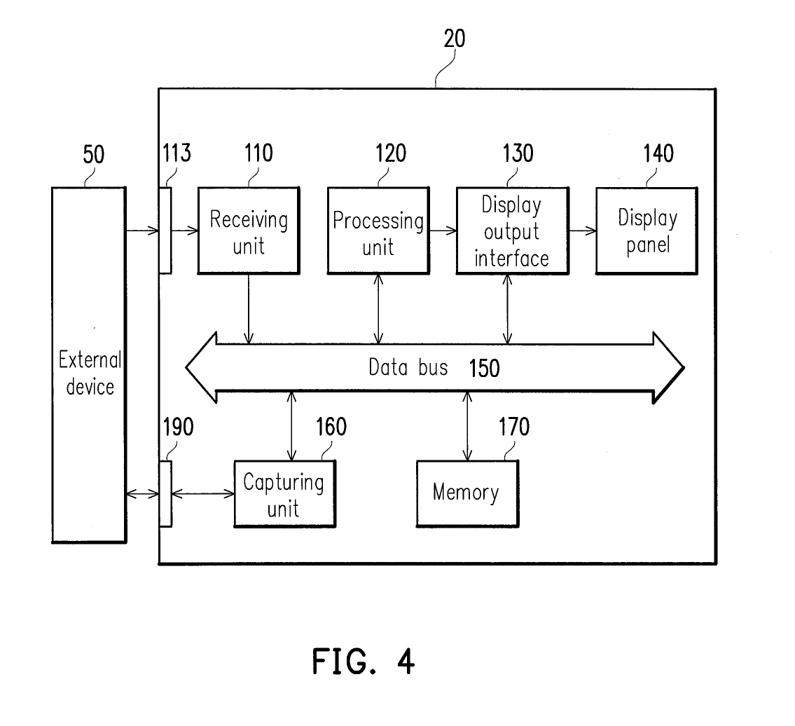

FIG. 4 is a schematic functional block view illustrating a display apparatus and an external device according to another embodiment of the invention. Details of the embodiment shown in FIG. 4 may be referred to as the details shown in FIG. 1 to FIG. 3. For instance, the external device 50 may be a computer host, an advertisement/broadcast host, or any other external electronic device with an HDMI or a USB interface, which should not be construed as a limitation to the invention. With reference to FIG. 4, in the present embodiment, the display apparatus 20 not only includes the receiving unit 110, the processing unit 120, the display output interface 130, the display panel 140, and the capturing unit 160 but also includes a memory 170, an HDMI 113, and a USB interface 190. The memory 170, the HDMI 113, and the USB interface 190 will be explained hereinafter, while the other components are already described in the embodiment shown in FIG. 1 and therefore will not be further elaborated.

The memory 170 is coupled to the data bus 150 and stores the video stream data output from the receiving unit 110 and/or the display data output from the processing unit 120. According opt the actual design demands, the memory 170 may be a volatile memory, a non-volatile memory (NVM), or a hard drive, which should not be construed as a limitation to the invention. In the present embodiment, the capturing unit 160 may capture from the memory 170 the video stream data or the display data as the captured target data. The external device 50 may provide the external video source. The receiving unit 110 receives the video stream data provided by the video source (i.e., the external device) through the HDMI 113, and the capturing unit 160 receives the capturing command of the external device 50 and transmits the captured target data back to the external device 50 through the USB interface 190.

As shown in FIG. 4, the external device 50 provides the external video source to the display apparatus 20 through the HDMI 113. Since the display apparatus 20 receives the capturing command and transmits the captured target data back to the external device 50 through the USB interface 190, the external device 50 is an electronic device with a USB host, such as a notebook computer, a mobile phone, or a personal digital assistant (PDA). The USB interface and the HDMI are exemplified in the present embodiment, while the HDMI may be replaced by the USB interface, the DisplayPort interface, or the VGA interface in other embodiments of the invention. Likewise, the USB interface described herein may be replaced by the thunderbolt interface, the HDMI, or the DisplayPort interface.

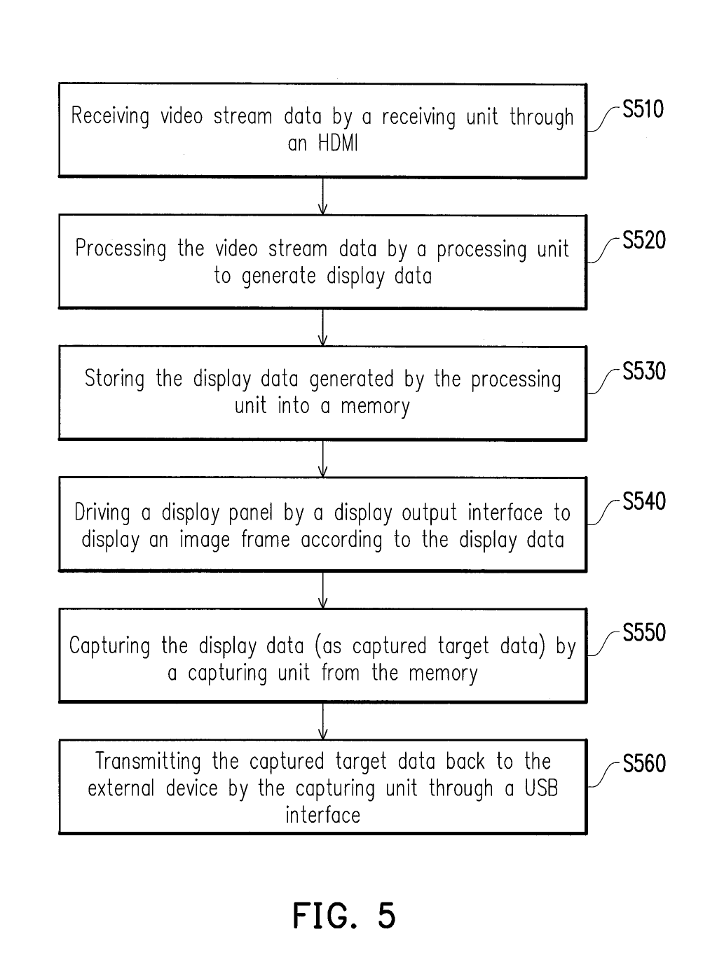

FIG. 5 is a flow chart of an image capturing method according to another embodiment of the invention. With reference to FIG. 4 and FIG. 5, the image capturing method is initiated by performing step S510. In step S510, the receiving unit 110 of the display apparatus 20 receives the video stream data through the HDMI 113. In step S520, the processing unit 120 processes the video stream data to generate display data.

In step S530, the memory 170 of the display apparatus 20 stores the display data generated by the processing unit 120. In step S540, the display output interface 130 drives the display panel 140 according to the display data stored in the memory 170, so as to display an image frame. In the present embodiment, it should be mentioned that the memory 170 stores the display data after the processing unit 120 generates the display data, and the display output interface 130 obtains the display data from the memory 170.

In step S550, the capturing unit 160 captures the display data as the captured target data from the memory 170. In step S560, the capturing unit 160 transmits the captured target data back to the external device 50 through the USB interface 190. In addition, according to another embodiment of the invention, the receiving unit 110 may store the video stream data of the external device 50 into the memory 170, such that the processing unit 120 may obtain or process the stored video stream data. Hence, the capturing unit 160 is able to capture from the memory 170 the video stream data (as the captured target data) stored by the receiving unit 110.

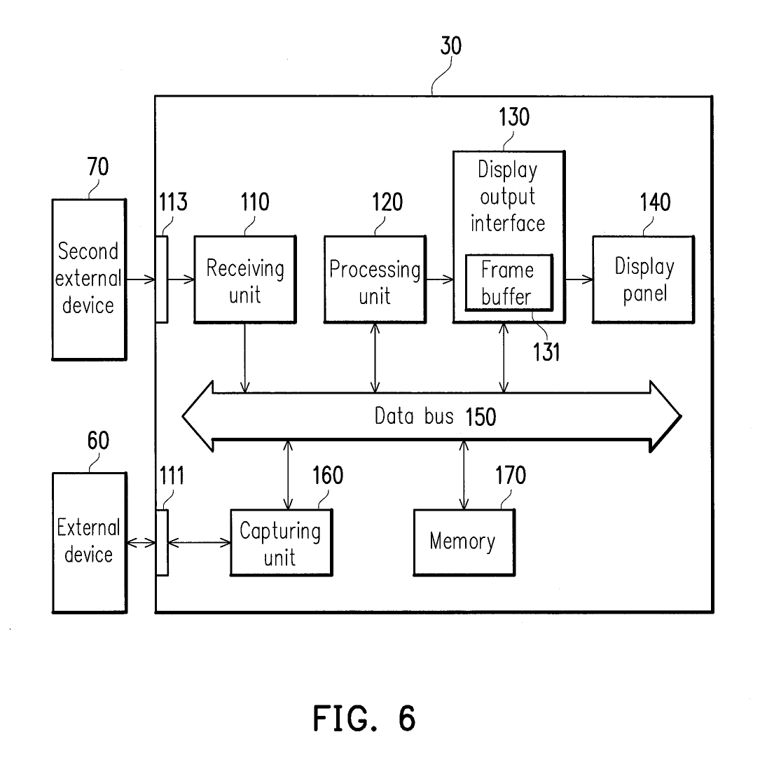

FIG. 6 is a schematic functional block view illustrating a display apparatus and an external device according to another embodiment of the invention. Details of the embodiment shown in FIG. 6 may be referred to as the details shown in FIG. 1 to FIG. 5. With reference to FIG. 6, the display output interface 130 of the display apparatus 30 further includes a frame buffer 131. The frame buffer 131 temporarily stores the display data output by the processing unit 120 or temporarily stores the video data that has undergone other image processing steps by the display output interface 130. In the present embodiment, the frame buffer 131 is able to act as the buffer for data access between the display panel 140 and the display output interface 130. Hence, according to the present embodiment, the capturing unit 160 may, through the processing unit 120, capture content of the frame buffer 131 of the display output interface 130 as the captured target data. According to another embodiment, the capturing unit 160 may directly capture the content of the frame buffer 131 as the captured target data.

As shown in FIG. 6, it should be mentioned that the external video source of the display apparatus 30 is provided by a second external device 70 instead of the external device 60. The second external device 70 capable of providing the video source is, for instance, a multi-functional DVD player or a camcorder. The display apparatus 30 receives the video stream data provided by the second external device 70 through the HDMI 113. Besides, the capturing unit 160 of the display apparatus 30 receives the capturing command from the external device 60 and transmits the captured target data back to the external device 60 through a thunderbolt interface 111. Here, the external device 60 may be any electronic device with a thunderbolt interface for receiving the captured target data transmitted by the display apparatus 30. The thunderbolt interface 111 is exemplified in the present embodiment, while the thunderbolt interface 111 may be replaced by the USB interface, the HDMI, or the DisplayPort interface in other embodiments of the invention.

As described above, the external device that provides the external video source may be or may not be the external device that receives the captured target data and issues the capturing command. In addition, the capturing command described in the previous embodiments is issued by a user through an external device, while the display apparatus may further include a trigger unit in another embodiment. A user is able to trigger an image capturing function of the display apparatus through the trigger unit, which will be elaborated in the following embodiment.

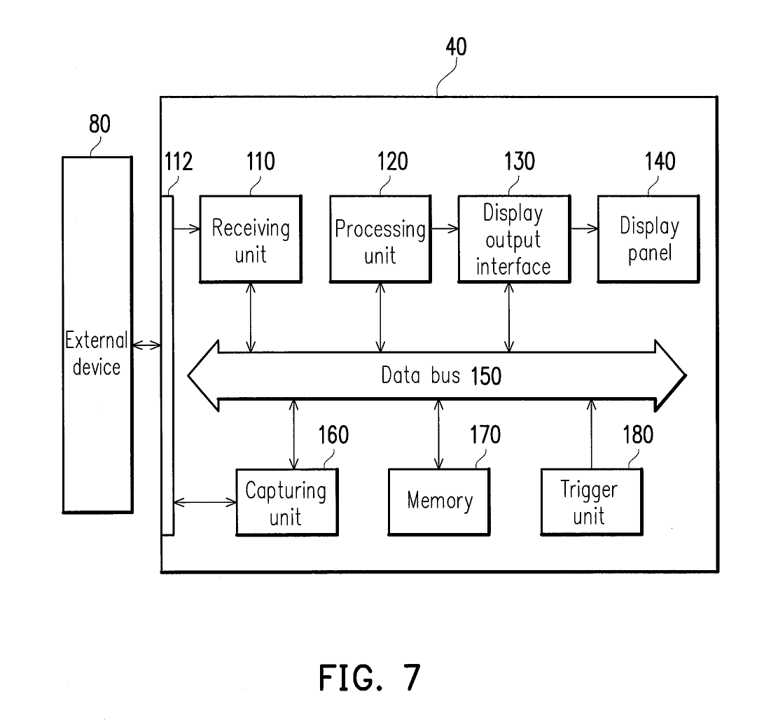

FIG. 7 is a schematic functional block view illustrating a display apparatus and an external device according to another embodiment of the invention. Details of the embodiment shown in FIG. 7 may be referred to as the details shown in FIG. 1 to FIG. 6. With reference to FIG. 7, the display apparatus 40 described in the present embodiment further includes a trigger unit 180 and a USB interface 112, while the USB interface 112 may be replaced by the thunderbolt interface, the HDMI, or the DisplayPort interface in other embodiments of the invention. The trigger unit 180 is coupled to the data bus 150 for detecting a trigger signal and outputting a capture activation signal to the capturing unit 160 through the data bus 150. In another embodiment of the invention, the trigger unit 180 may be directly coupled to the capturing unit 160 for easily outputting the capture activation signal to the capturing unit 160.

The capturing unit 160 outputs the capture activation signal from the trigger unit 180 to the external device 80 through the USB interface 112, so as to trigger the external device 80 to issue the capturing command. For instance, the trigger unit 180 may be equipped with a press button that is located on the display apparatus 40. As long as a user intends to capture the image frame displayed by the display apparatus 40, the user may press the press button to activate the image capturing function of the display apparatus 40. According to the capture activation signal output by the trigger unit 180, the external device 80 issues the capturing command to the display apparatus 40 and thereby controls the capturing unit 160 to capture the image. Details of the image capturing operation of the capturing unit 160 may be referred to as the details shown in FIG. 1 to FIG. 6 and will not be further described hereinafter.

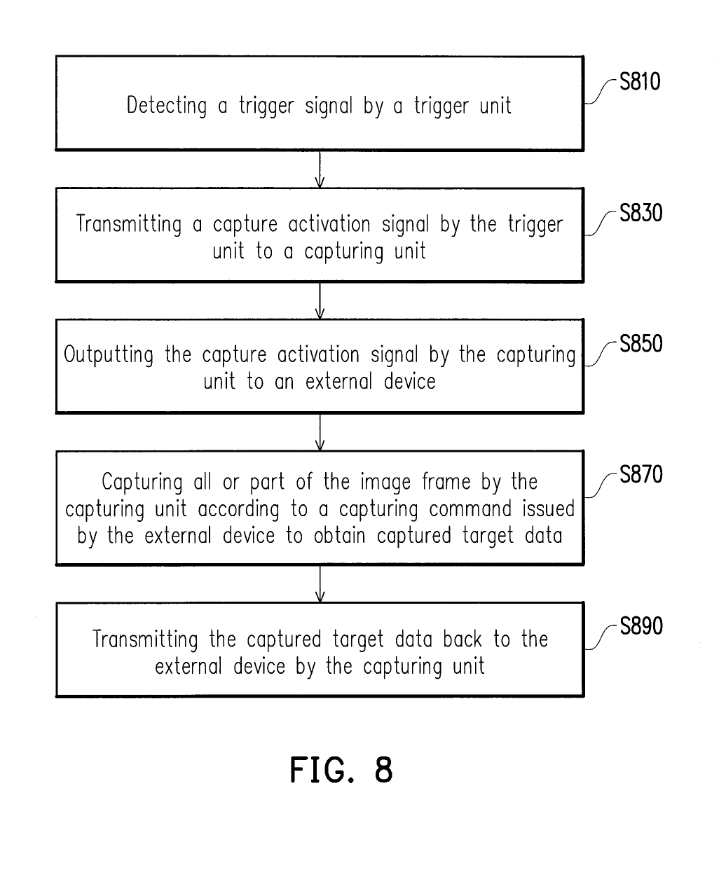

FIG. 8 is a flow chart of an image capturing method according to another embodiment of the invention. With reference to FIG. 7 and FIG. 8, through the USB interface 112, the display apparatus 40 described in the present embodiment receives the video stream data provided by the external apparatus 80 and displays the image frame on the display panel 140. Details of the image display operation of the display apparatus 40 may be referred to as the details shown in FIG. 1 to FIG. 6 and will not be further described hereinafter. While the display apparatus 40 displays the image frame, a user may trigger/press the trigger unit 180 any time. In step S810, the trigger unit 180 detects a trigger signal. If the trigger signal is detected, the trigger unit 180 in step S830 issues a capture activation signal to the capturing unit 160. For instance, after the user presses the press button of the trigger unit 180, the press button generates the trigger signal; if the trigger unit 180 detects the trigger signal, the trigger unit 180 outputs the capture activation signal to the capturing unit 160.

After the capturing unit 160 receives the capture activation signal from the trigger unit 180, the capturing unit 160 in step S850 outputs the capture activation signal from the trigger unit 180 to the external device 80 through the USB interface 112, so as to trigger the external device 80 to issue the capturing command. The following steps are the same as those described above. In step S870, the capturing unit 160 captures all or part of the image frame according to the capturing command issued by the external device 80, so as to obtain the captured target data. In step S890, the capturing unit 160 transmits the captured target data back to the external device 80 through the USB interface 112.

According to the descriptions provided in the previous embodiments, the receiving unit 110 and the capturing unit 160 may communicate with the external device through different interfaces or the same interface. Additionally, in other embodiments of the invention, the capturing unit 160 not only transmits the captured target data back to the external apparatus but also stores the captured target data into the memory or the hard drive in the display apparatus or into an external memory or an external hard drive (e.g., a compact flash memory card or a secure digital memory card).

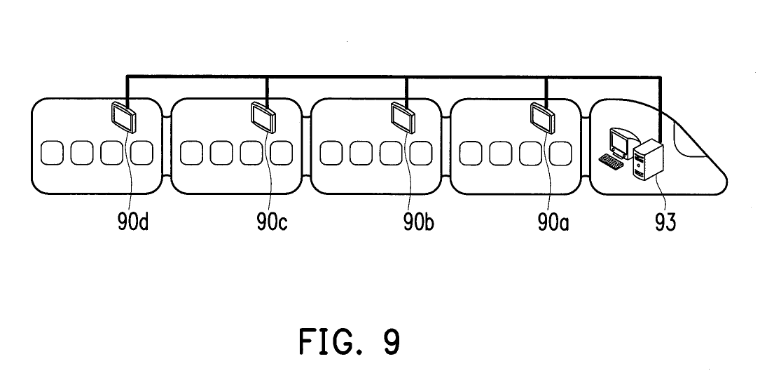

FIG. 9 is a schematic view briefly illustrating an scenario of applying the display apparatus according to another embodiment of the invention. As shown in FIG. 9, in a video/image broadcast system of a train, display apparatuses 90a to 90d are respectively placed at different cars of the train for receiving the video stream data provided by the external device (e.g., a broadcast host 93), such that passengers are able to watch a security promotional movie or a commercial short film. In order to learn whether or not the display apparatuses 90a to 90d broadcast the movie or the film properly and correctly, the conductor of the train may issue the capturing command to the display apparatuses 90a to 90d through the broadcast host 93. After the display apparatuses 90a to 90d receive the capturing command, the display apparatuses 90a to 90d start to capture their internal display data and transmit the captured target data back to the broadcast host 93. Details of issuing the capturing command by the broadcast host 93 and details of capturing the display data by the display apparatuses 90a to 90d according to the capturing command may be referred to as the details shown in FIG. 1 to FIG. 8 and will not be further described hereinafter.

According to the captured target data transmitted back to the broadcast host 93, the conductor of the train is able to check the image frame that is being displayed by each of the display apparatuses 90a to 90d for fear that errors of image data may occur during data transmission. Furthermore, it is not necessary for the conductor of the train to go to each car for checking the display apparatuses 90a to 90d. Since the image capturing function of the video/image broadcast system is mainly performed to check whether the image frame is displayed in a normal, correct manner, high resolution of the captured image is not required. Accordingly, the capturing unit of each display apparatus 90a to 90d may be controlled by the capturing command to adjust the resolution of the captured target data and reduce the file size of the captured target data; thereby, the load of data transmission may be alleviated.

To sum up, in the display apparatus and the image capturing method thereof, the capturing unit configured in the display apparatus is employed to capture the image data of the displayed image frame, such that the image frame that is being displayed by the display apparatus may be captured in full at any time, and that various image capturing issues resulting from software limitations may be resolved. Moreover, regardless of the video source provider, the display apparatus described herein is able to capture the image frame that is being displayed, and thus the image frame to be recorded by a user may be captured and stored. In the display apparatus and the image capturing method thereof, all or part of the image frame may be obtained according to users' demands, and the resolution of the captured target data may also be adjusted. What is more, the display apparatus described herein is applicable to a video broadcast system, such that the video/image broadcast by plural display apparatuses may be inspected.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A display apparatus comprising:
a receiving unit coupled to a data bus, the receiving unit receiving video stream data provided by an external video source;
a processing unit coupled to the data bus, the processing unit processing the video stream data to generate display data;
a display panel;
a display output interface coupled to the processing unit and the display panel, the display output interface receiving the display data to drive the display panel to display an image frame; and
a capturing unit coupled to the data bus, the capturing unit capturing all or part of the image frame according to a capturing command issued by an external device, so as to obtain captured target data, the capturing unit transmitting the captured target data back to the external device.

2. The display apparatus as recited in claim 1, wherein the receiving unit receives the video stream data provided by the external video source through a universal serial bus interface, a thunderbolt interface, a high definition multimedia interface, a DisplayPort interface, or a video graphics array interface.

3. The display apparatus as recited in claim 1, wherein the capturing unit transmits the captured target data back to the external device through a universal serial bus interface, a thunderbolt interface, a high definition multimedia interface, or a DisplayPort interface.

4. The display apparatus as recited in claim 1, wherein the capturing unit receives the capturing command issued by the external device through a universal serial bus interface, a thunderbolt interface, a high definition multimedia interface, or a DisplayPort interface.

5. The display apparatus as recited in claim 1, further comprising:
a memory coupled to the data bus, the memory storing the video stream data or the display data.

6. The display apparatus as recited in claim 5, wherein the capturing unit captures the video stream data or the display data as the captured target data from the memory.

7. The display apparatus as recited in claim 1, wherein the capturing unit captures content of a frame buffer of the display output interface as the captured target data.

8. The display apparatus as recited in claim 1, wherein the capturing unit further adjusts resolution of the captured target data according to the capturing command.

9. The display apparatus as recited in claim 1, further comprising:
a trigger unit coupled to the data bus, the trigger unit detecting a trigger signal and outputting a capture activation signal to the capturing unit through the data bus.

10. The display apparatus as recited in claim 9, wherein the capturing unit outputs the capture activation signal to the external device, so as to trigger the external device to issue the capturing command.

11. The display apparatus as recited in claim 1, wherein the external device provides the external video source.

12. The display apparatus as recited in claim 1, wherein the external video source is provided by a second external device.

13. An image capturing method of a display apparatus, comprising:
receiving video stream data from a receiving unit;
processing the video stream data by a processing unit to generate display data;
driving a display panel by a display output interface according to the display data, so as to display an image frame;
capturing all or part of the image frame by a capturing unit according to a capturing command issued by an external device to obtain captured target data; and
transmitting the captured target data back to the external device by the capturing unit.

14. The image capturing method as recited in claim 13, wherein the receiving unit receives the video stream data provided by the external video source through a universal serial bus interface, a thunderbolt interface, a high definition multimedia interface, a DisplayPort interface, or a video graphics array interface.

15. The image capturing method as recited in claim 13, wherein the capturing unit transmits the captured target data back to the external device through a universal serial bus interface, a thunderbolt interface, a high definition multimedia interface, or a DisplayPort interface.

16. The image capturing method as recited in claim 13, wherein the capturing unit receives the capturing command issued by the external device through a universal serial bus interface, a thunderbolt interface, a high definition multimedia interface, or a DisplayPort interface.

17. The image capturing method as recited in claim 13, further comprising:
storing the video stream data or the display data into a memory of the display apparatus.

18. The image capturing method as recited in claim 17, wherein the step of capturing all or part of the image frame according to the capturing command comprises:
capturing the video stream data or the display data as the captured target data from the memory.

19. The image capturing method as recited in claim 13, wherein the step of capturing all or part of the image frame according to the capturing command comprises:
capturing content of a frame buffer of the display output interface as the captured target data.

20. The image capturing method as recited in claim 13, further comprising:
adjusting resolution of the captured target data by the capturing unit according to the capturing command.

21. The image capturing method as recited in claim 13, further comprising:
storing the captured target data into a memory of the display apparatus.

22. The image capturing method as recited in claim 13, further comprising:
detecting a trigger signal by a trigger unit; and
if the trigger signal is detected, issuing a capture activation signal to the capturing unit by the trigger unit.

23. The image capturing method as recited in claim 22, further comprising:
outputting the capture activation signal to the external device by the capturing unit, so as to trigger the external device to issue the capturing command.
